(19) United States
(12) Patent Application Publication
(10) Pub. No.: US 2013/0080331 A1
(43) Pub. Date: Mar. 28, 2013

(54) System and Method for Instantaneous Retail Payment

(71) Applicant: EBAY INC., San Jose, CA (US)

(72) Inventors: John Hastings Granbery, Boston, MA (US); Sebastien Taveau, Redwood City, CA (US); Mate Soos, Berlin (DE); Karsten Nohl, Berlin (DE)

(73) Assignee: EBAY INC., San Jose, CA (US)

(21) Appl. No.: 13/627,964

(22) Filed: Sep. 26, 2012

Related U.S. Application Data
(60) Provisional application No. 61/539,327, filed on Sep. 26, 2011.

(51) Int. Cl. G06Q 20/38

(52) U.S. Cl. CPC G06Q 20/3829; G06Q 20/4016
USPC 705/71; 705/39

(57) ABSTRACT

A system for performing a retail payment between a customer and a merchant is provided. The system includes a signed scrip having a public key, a credit value, a signed scrip validation stamp, a credit value, and a validation stamp; a signed invoice comprising a transaction list and an invoice validation stamp; and a private key complementary to the public key, wherein the public key is used to decode the signed scrip; the private key is stored in a server coupled to a network; and the private key is used by the server to validate the authenticity of the signed invoice. Also provided is a method for performing a financial transaction using a system as above; and a non-transitory machine-readable medium including a plurality of machine-readable instructions to cause a server to perform a method as above, is provided.

### CROSS REFERENCE TO RELATED APPLICATIONS

The present disclosure is related to and claims the priority of U.S. Provisional Patent Application No. 61/539327, entitled SIGNED SCRIP FOR INSTANTANEOUS RETAIL PAYMENT, by Sebastien Taveau, Mate Soos, Karsten Nohl, and Hastings Granbery, filed on Sep. 26, 2011, the contents of which are hereby incorporated by reference in their entirety, for all purposes.

### BACKGROUND

1. Technical Field

Embodiments disclosed herein relate generally to the field of retail payments using validated and secured credit certificates or signed scrips. More particularly, embodiments disclosed herein relate to the field of retail payments using validated and secured credit certificates or signed scrips issued by a private account service provider over a network.

2. Description of Related Art

Retail payment systems today work typically by a customer presenting payment credentials to a merchant. The merchant then makes a remote connection to a server or to a financial institution to verify the credentials presented by the customer. For example, the customer might swipe a credit card through a terminal provided by the merchant. The merchant then uses a network connection to a bank and finds out if the account associated with the credit card can afford the purchase. The amount of time to obtain the validation information on a credit card account using this method may be several seconds. In some circumstances, it may take 5 to 10 seconds to pass through the entire payment network. In a worst case scenario, the entire transaction may be cancelled due to lack of network connectivity at the time of purchase. Even large retailers having effective and state-of-the-art network accessibility have decided that the time spent on validating every transaction is not worth the risk for low value purchases. Thus, large retailers simply do not check for validation of credit card transactions at the time of sale for purchases under a certain amount. Although reduced, this approach leaves open the potential for financial loss. Moreover, for transactions involving larger amounts, the extra time is unavoidable, which for a large retailer may accrue into several hours of idle time per day. This also has an impact on the length of customer lines at the cashier, customer turnover, and customer satisfaction.

What is needed is a system and a method for instantaneous retail payment that provides a secure validation procedure.

### BRIEF DESCRIPTION OF THE DRAWINGS

FIG. 1 illustrates a system for instantaneous retail payment, according to some embodiments.

FIG. 2 illustrates a plurality of encryption keys used in a system for instantaneous retail payment, according to some embodiments.

FIG. 3 illustrates a signed scrip for a user in an instantaneous retail payment, according to some embodiments.

FIG. 4 illustrates an invoice from a merchant in an instantaneous retail payment, according to some embodiments.

FIG. 5 illustrates a reduced scrip having a reduced value according to some embodiments.

FIG. 6 illustrates a timeline in a system for instantaneous retail payment, according to some embodiments.

FIG. 7 illustrates a trajectory in a system for instantaneous retail payment, according to some embodiments.

FIG. 8 illustrates a flow chart of a method for instantaneous retail payment, according to some embodiments.

FIG. 9 illustrates a flow chart of a method for instantaneous retail payment, according to some embodiments.

In the figures, elements having the same reference number have the same or similar functions.

### DETAILED DESCRIPTION

Near Field Communication (NFC) hardware, implemented in a wide variety of mobile electronic devices, provides a platform to achieve instantaneous or quasi-instantaneous validation of retail payments. Current NFC payment schemes may use a card emulation procedure and a stored value procedure. In card emulation procedures, the mobile device having NFC capabilities acts as if it were a credit card being tapped on a reader. The reader collects the credit information and relies on traditional credit card validating procedures to authorize the transaction, thus eliminating any time advantage over credit card transactions. In a stored value procedure, funds are transferred onto a mobile device having NFC capability at a particular place and time. The fund transfer in a stored value procedure is associated with a specific merchant. Stored value procedures are commonly used in urban transit systems, and typically take a very short time since communication between the customer device and the merchant device is much faster than access of a remote server through a network. However, if the mobile device is lost or stolen, there is no simple way to retrieve the value stored in the device for use with the specific merchant. Moreover, in a stored value procedure, funds stored in a mobile device are allocated to a specific merchant and may not be used for a different merchant. Furthermore, in a stored value procedure, there is the constant need to replenish the account balance, to avoid a shortage of funds in circumstances where fund allocation may be difficult, or too time consuming. While embodiments of the present disclosure use NFC hardware, this particular approach is not limiting. One of ordinary skill would recognize that any hardware that transmits information between a customer device and a merchant device may be implemented in embodiments consistent with the present disclosure.

According to embodiments disclosed herein, a private account service provider such as PayPal, Inc. of San Jose, Calif. is able to combine the benefits of a card emulation procedure and a stored value procedure. Thus, according to some embodiments, a private account service provider may guarantee instantaneous transactions at the point of sale between a merchant and a customer. In some embodiments, the customer and the merchant may be registered users with the private account service provider.

According to embodiments disclosed herein, a system for performing a retail payment between a customer and a merchant may include a signed scrip, the signed scrip comprising: a public key, a credit value, a signed scrip validation stamp, a credit value, and a validation stamp; a signed invoice including a transaction list and an invoice validation stamp; and a private key complementary to the public key, wherein the public key is used to decode the signed scrip; the private key is stored in a server coupled to a network; and the private key is used by the server to validate the authenticity of the signed invoice.

According to some embodiments, a method for performing a financial transaction includes receiving a request, by a service provider from a customer through a customer device, to generate a signed scrip; transmitting, by the service provider, the signed scrip to the customer device, wherein the signed scrip is stored on the customer device and comprises an amount, a geographic restriction, and a time restriction; and receiving, by the service provider, a reduced scrip from the customer and from a merchant, wherein the signed scrip was used to make a payment to the merchant using a link between the customer and the merchant, and wherein the reduced scrip is generated by the merchant.

Further according to some embodiments a non-transitory machine-readable medium may include a plurality of machine-readable instructions which when executed by one or more processors of a server controlled by a service provider are adapted to cause the server to perform a method including receiving a credit request from a customer; determining credit parameters; creating a public key; providing a signed scrip to a customer; receiving credentials from a merchant; and providing the public key to the merchant.

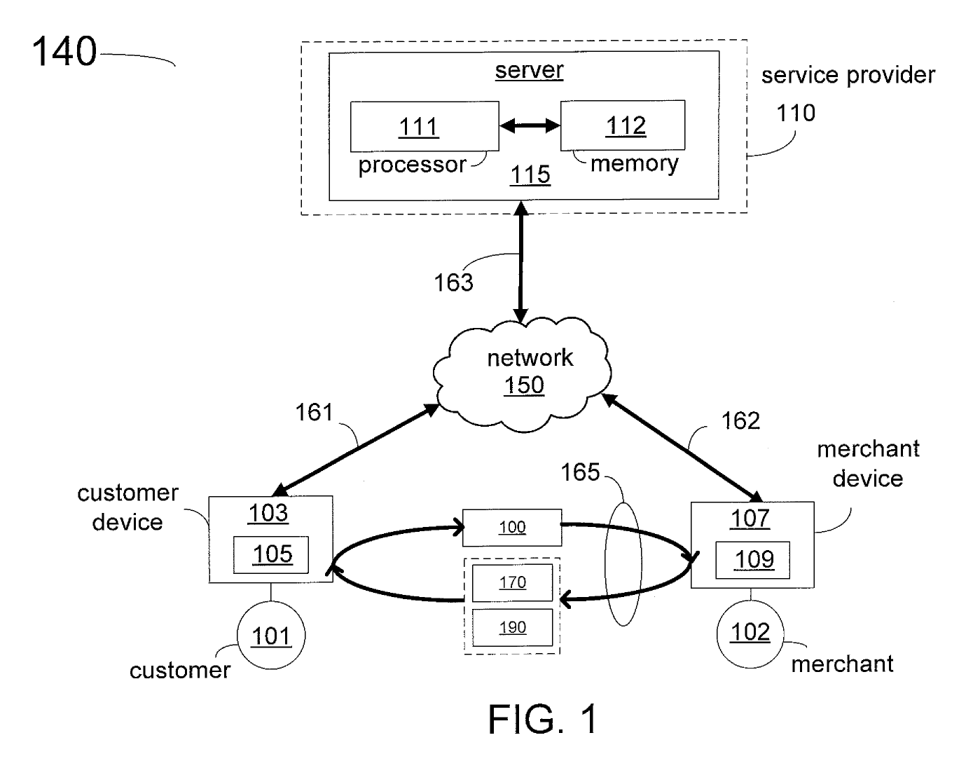

FIG. 1 illustrates a system 140 for instantaneous retail payment, according to some embodiments. System 140 includes a private account service provider 110, and a customer 101 having a customer device 103 such as a cell phone, computing tablet, or other mobile device. System 140 may also include a merchant 102 having a merchant device 107 such as a credit card reader with NFC. Accordingly, service provider 110, customer device 103, and merchant device 107 are able to communicate with each other through a network 150. Customer device 103 is coupled to network 150 through link 161. Merchant device 107 is coupled to network 150 through link 162. And service provider 110 is coupled to network 150 through link 163. Customer 101 and merchant 102 may have private accounts with service provider 110. Customer device 103 and merchant device 107 may be configured to access service provider 110 on a regular basis, through network 150. In some embodiments, to complete a purchase transaction instantaneously, customer device 103 and merchant device 107 may exchange information through a local link 165. For example, a local link 165 may be through NFC device 105 installed in customer device 103 and NFC device 109 installed in merchant device 107. The information exchanged through link 165 may include a credit certificate, or “signed scrip” 100 transmitted from customer 101 to merchant 102. In some embodiments, the information exchanged through link 165 may include an invoice 170 and a reduced credit certificate, or “reduced scrip” 190 transmitted from merchant 102 to customer 101.

Service provider 110 includes a server 115 having a processor circuit 111 and a memory circuit 112. Server 115 may store a table of passwords associated with login names of the private accounts registered with service provider 110 in memory circuit 112. Server 115 may have information regarding login names and passwords/PINs stored in memory circuit 112. Links 161, 162, and 163 may include wires, cables, optical fibers, wireless Radio-Frequency (RF) transceivers, or any combination of the above. Thus, links 161, 162, and 163 may transmit electronic signals, optical signals, or RF signals, in digital or analogue form.

In some embodiments consistent with the present disclosure, customer 101 may install an application from service provider 110 in customer device 103. Customer 101 may thus log in to a user account with service provider 110 using customer device 103. The application installed in customer device 103 may receive from server 115 a “signed scrip” 100 through link 161, for a small amount of geographically and temporally restricted credit. For example, in some embodiments signed scrip 100 may include a value of $50 for a period of six hours starting from the time of transmission through link 163, within 25 miles of the location at which customer 101 requests the signed scrip from server 115. Customer device 103 stores the credit until it is presented for payment at merchant device 107. The time between receipt of signed scrip 100 through link 161 and redemption of all or part of the credit at a merchant device 107 may be immediate or may be hours later, as long as signed scrip 100 is still valid.

According to some embodiments, customer device 103 contacts merchant device 107 using NFC 105, requesting an invoice. Merchant device 107 provides invoice 170 to customer device 103; when the amount in invoice 170 is less than the credit amount of signed scrip 100, customer device 103 provides merchant device 107 with signed scrip 100. Merchant device 107 deducts the amount of purchase from signed scrip 100 and provides reduced scrip 190 in return. Customer device 103 may store reduced scrip 190 locally, for further use. During the transaction, customer 101 or merchant 102 may not need to access server 115 through network 150.

According to some embodiments, when merchant device 107 has connectivity (which may be immediately during the transaction), it may transmit a copy of reduced scrip 190 to server 115 through network link 162. Server 115 reconciles the transaction by assessing the authenticity of reduced scrip 190. When service provider 110 establishes that the transaction between customer 101 and merchant 102 is genuine, service provider 110 may provide funds in the transaction amount to a merchant's account. Also, service provider 110 may deduct the user private account in the transaction amount, or just note that a portion of the credit in the transaction amount has been used.

Similarly, when customer device 103 has connectivity to network 150 through link 161, it sends a copy of reduced scrip 190 to server 115. In some embodiments, server 115 may issue new signed scrip 100 to customer 101. In some embodiments, server 115 may store in memory circuit 112 information related to the transaction, including the amount of credit that has been used. Accordingly, service provider 110 receives information about the purchasing transaction from customer 101 and from merchant 102. Service provider 110 is thus able to reconcile the transaction information received from customer 101 and merchant 102, and establish the validity of the transaction.

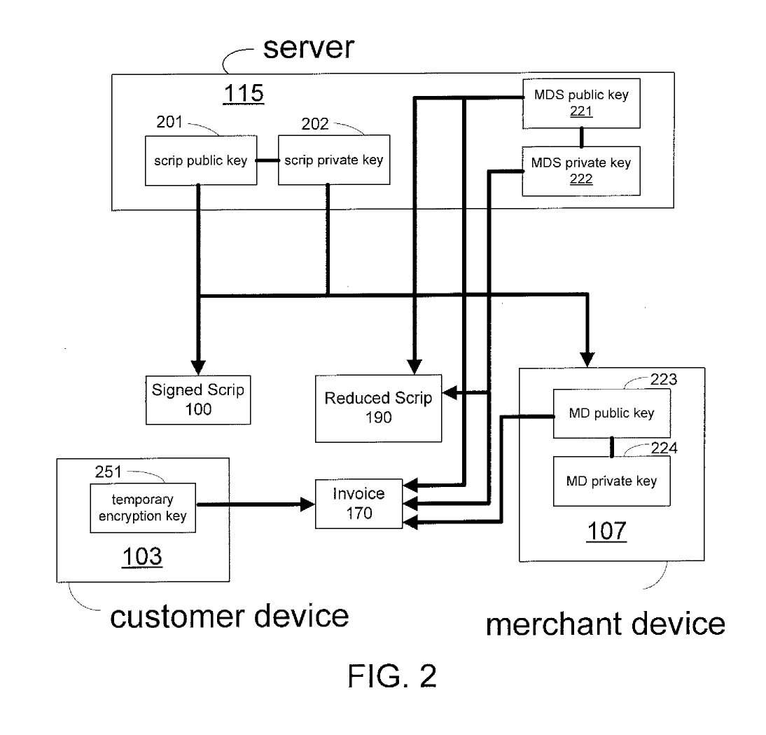

FIG. 2 illustrates a plurality of encryption keys used in system 140 for instantaneous retail payment, according to some embodiments. According to some embodiments, at least some encryption keys illustrated in FIG. 2 are generated by asymmetric encryption algorithms. The asymmetric encryption algorithm may include commands stored in memory circuit 112, the commands being performed by processor circuit 111. For example, server 115 may generate a signed scrip public key 201 and a signed scrip private key 202 complementary to each other. Server 115 may also generate a merchant device signing (MDS) public key 221 and a merchant device signing (MDS) private key 222 complementary to each other, using an asymmetric encryption algorithm. In some embodiments, merchant device 107 may generate a merchant device (MD) public key 223 and a merchant device (MD) private key 224 using an asymmetric encryption algorithm. Customer device 103 may generate a temporary encryption key (tmpk) 251. According to some embodiments, tmpk 251 may be a symmetric key used to encode and decode encrypted messages interchanged between customer device 103 and merchant device 107 for a restricted period of time.

In some embodiments, public key 201 may be encoded in an X.509 certificate, signed by a certification authority (CA) trusted on all the major phone operating systems. Public key 201 may be the root certificate for all subsequent verification steps by server 115. In some embodiments, public key 201 is passed along to the users in signed scrip 100. Private key 202 may be stored by memory circuit 112 in server 115. The security of private key 202 guarantees the reliability of the authentication process in server 115. Private key 202 may also be referred to as the Root Certificate (RC). Any party can confirm the authenticity of signed scrip 100 by verifying public key 201 with RC 202.

In some embodiments, server 115 may send a certificate to verify scrip signatures to merchant device 107. Thus, merchant devices 107 may authenticate the validity of signed scrip 100 presented by customer 101 through local link 165. In some embodiments, customer device 103 and merchant device 107 may have a copy of RC 202.

Signed scrip public key 201 may be associated with a specific period of time during which signed scrip 100 is valid. Signed scrip public key 201 may be used by merchant device 107 for authentication when customer 101 presents signed scrip 100 to merchant 102 by using RC 202 from server 115. Furthermore, after the transaction is complete, server 115 may receive a first copy of reduced scrip 190 from customer 101 and a second copy from merchant 102. In such embodiments, server 115 may authenticate public key 201 in reduced scrip 190, using RC 202, verifying that signed scrip 100 was originally generated by server 115.

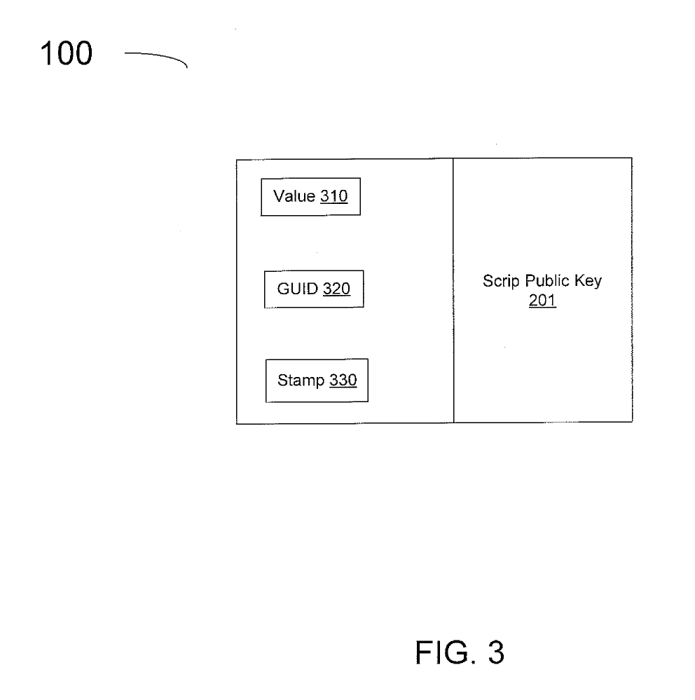

FIG. 3 illustrates a signed scrip 100 for a user in instantaneous retail payment, in system 140, according to some embodiments. Signed scrip 100 includes a value 310, a global unique identifier (GUID) 320, a stamp 330, and signed scrip public key 201. The stamp 330 may include information visible to the user, such as a time and a location indicating the validity of signed scrip 100. Value 310 is a credit value awarded to signed scrip 100 by service provider 110. In some embodiments, service provider 110 uses processor circuit 111 and memory circuit 112 to collect data from the private account of customer 101 and establish a risk assessment of the user. Thus, processor circuit 111 and memory circuit 112 may operate as a “risk engine” to determine with a certain confidence level a value 310 that may be awarded to signed scrip 100 for customer 101. In fact, service provider 110 is able to have a highly accurate assessment of the risk degree presented by customer 101, since memory circuit 112 may store a large amount of personal information from the user, such as purchasing history and financial habits.

GUID 320 associated with signed scrip 100 may be used for a revocation list if there is indication of abuse of system 140 by customer 101. In some embodiments GUID 320 includes a radius around a center point restricting the geographical use of signed scrip 100. GUID 320 may also include an expiration date. The expiration date may be earlier than a pre-selected period of time, or “Epoch.” According to some embodiments, signed scrip 100 may have a validity for a pre-selected period of time, in a particular location. The expiration time and the restricted geographic area for signed scrip 100 may be printed in stamp 330.

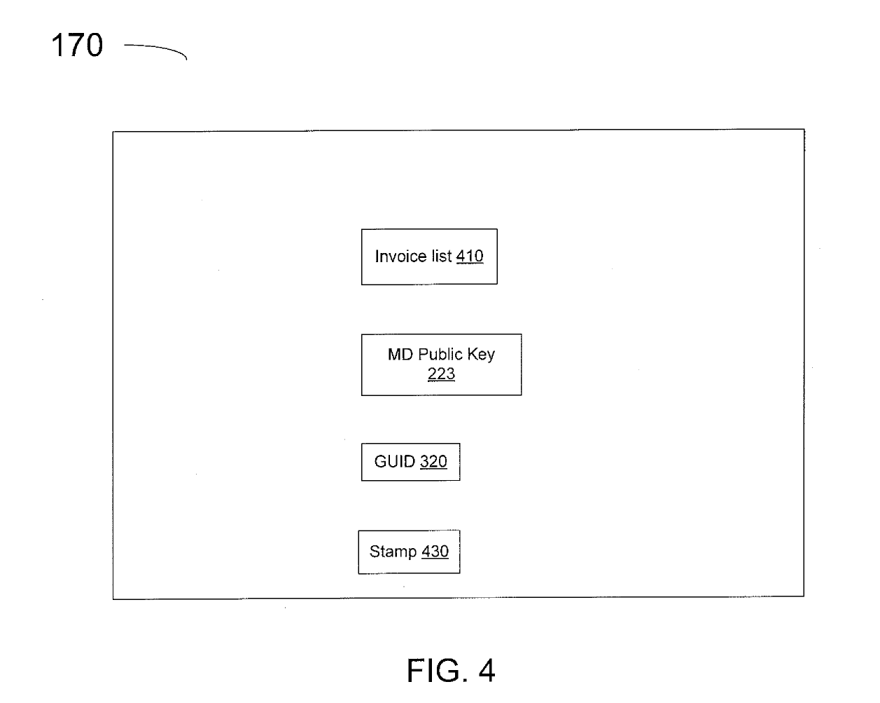

FIG. 4 illustrates invoice 170 from merchant device 107 in instantaneous retail payment system 140, according to some embodiments. Invoice 170 includes invoice list 410, GUID 320, and MD public key 223. GUID 320 has been described in detail above, in reference to FIG. 3. Invoice list 410 includes a list of items that customer 101 desires to purchase from merchant 102 at the point of sale, and a total cost. In some embodiments, invoice 170 may include a stamp 430. Stamp 430 may include a time stamp and a location stamp, corresponding to the time and location where invoice 170 was generated by merchant device 107.

MD private key 224 may be used to decode messages from merchant 102 to customer 101 by customer device 103. MD private key 224 may be stored in merchant device 107 and is not shown in FIG. 4.

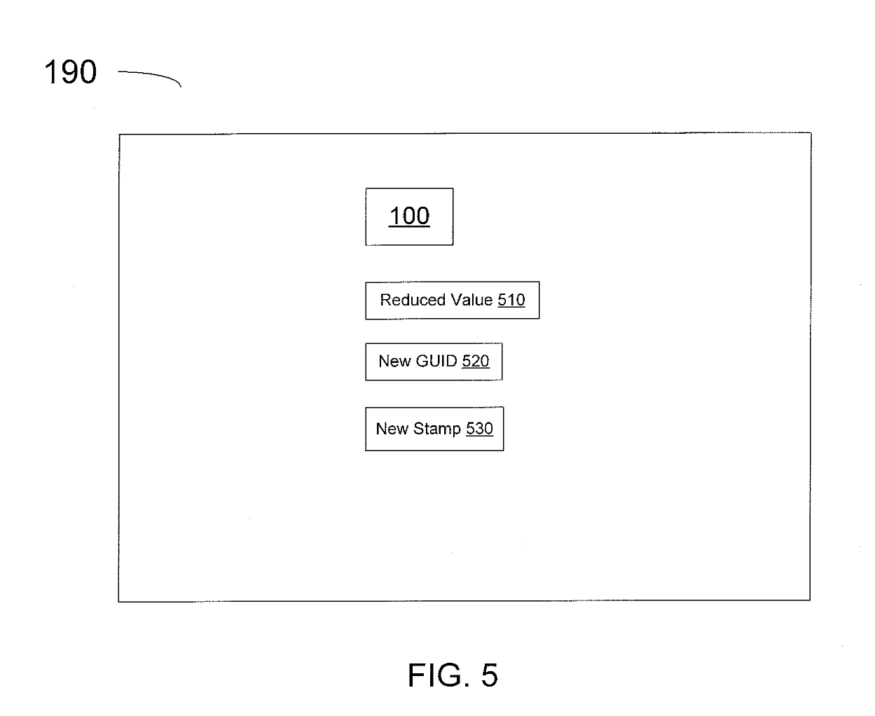

FIG. 5 illustrates reduced scrip 190 having a reduced value 510, according to some embodiments. Reduced scrip 190 may be generated by merchant device 107 after a transaction involving signed scrip 100 has been completed successfully. Thus, reduced value 510 may be the result of subtracting the total cost in invoice list 410 (cf. FIG. 4) from value 310 (cf. FIG. 3). Reduced scrip 190 may include a copy of the original signed scrip 100, including signed scrip public key 201. A new GUID 520 may be included, so that reduced scrip 190 may be distinguished from signed scrip 100. In some embodiments GUID 520 includes a radius around a new center point restricting the geographical use of reduced scrip 190. GUID 520 may also include a new expiration date. The new expiration date may be earlier than a pre-selected period of time, or “Epoch.” According to some embodiments, reduced scrip 190 may have a validity for a pre-selected period of time, in a particular location. The expiration time and the geographic validation of signed scrip 100 may be printed in new stamp 530.

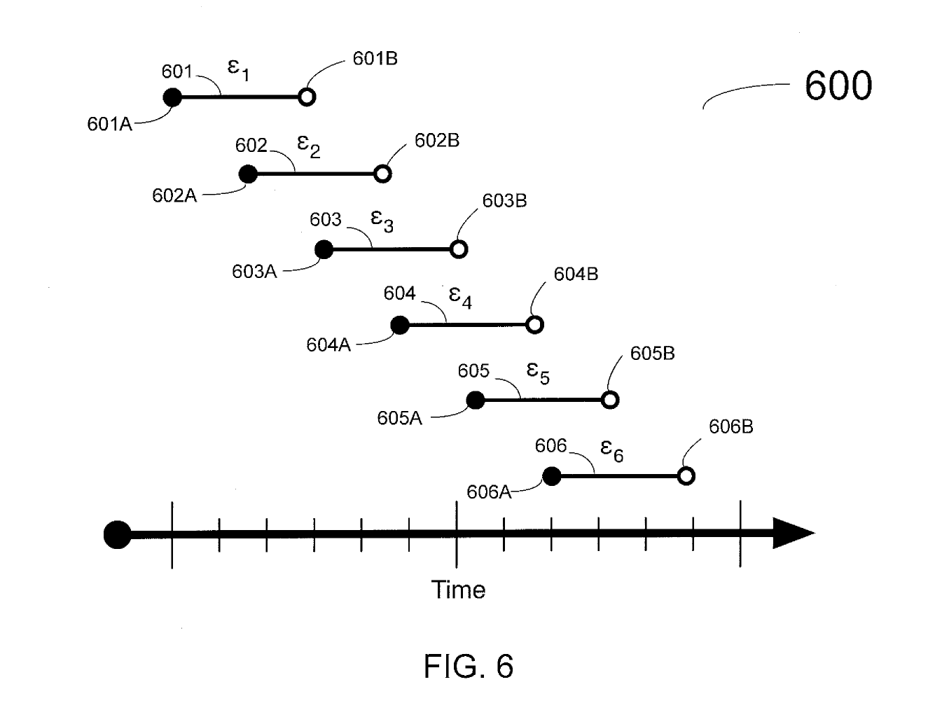

FIG. 6 illustrates a timeline 600 in a system 140 for instantaneous retail payments, according to some embodiments. Timeline 600 may include a plurality of Epochs, or time periods 601(ε₆₀₁), 602(ε₆₀₂), 603(ε₆₀₃), 604(ε₆₀₄), 605(ε₆₀₅), and 606(ε₆₀₆). Time periods 601 through 606 are sequential and numbered, so Epoch j (εⱼ) comes before Epoch k (εₖ) if j<k. Each Epoch has a start time and a deadline. For example, Epochs 601 through 606 have start times 601A through 606A and deadlines or end/expiration times 601B through 606B, respectively. Accordingly, in embodiments of an instantaneous retail payment system 140 each one of Epoch 601 through 606 may have associated with it a set of encryption keys (cf. FIG. 2). Thus, new encryption keys such as public key 201 and private key 202, may be created periodically by server 115, for each Epoch. Likewise, new encryption keys: MDS public key 221, MDS private key 222, MD public key 223, and MD private key 224 may be created periodically, for each Epoch. When the Epoch expires, encrypted keys associated with that Epoch also expire. In some embodiments, tmpk 251 is created by customer device 103 every time a purchase transaction occurs, and may be intended for the specific time during which customer 101 interacts with merchant 102 for the purchase. Accordingly, in some embodiments, tmpk 251 may not be bounded by an Epoch expiration.

Epochs may also overlap in time, for redundancy purposes. Thus, at any given time, Epochs εₙ and εₙ₊₁ may occur simultaneously after the start time of Epoch n+1 and before the deadline of Epoch n. Each Epoch εₙ and εₙ₊₁ may have a set of encryption keys associated with it (cf. FIG. 2), both sets of encryption keys may be valid, as long as the associated Epoch has not expired.

In some embodiments, merchant device 107 may be more trustworthy than customer device 103, and separate sets of Epochs may apply for merchant devices and customer devices. For example, Epochs for merchant devices may be longer than Epochs for customer devices. This may avoid generating large numbers of encryption keys for merchant devices on a regular basis, relieving memory usage in those devices. For illustration purposes, and without limitation, in the following embodiment the merchant device and the customer device will be assumed to have the same set of Epochs.

At the beginning of each Epoch εₙ, merchant 102 contacts server 115 with merchant credentials for a private account in service provider 110. Merchant 102 may contact server 115 using merchant device 107, and link 162 through network 150. According to some embodiments, server 115 gives merchant device 107 encrypted MDS public key 221 and encrypted MDS private key 222 for signing messages. MDS public key 221 may be as described in detail above (cf. FIG. 2) and may include an expiration date from the deadline for the current Epoch. Further according to some embodiments, MDS public key 221 may be signed by server 115 with public key 201. Public key 201 for the current Epoch may also be provided to merchant device 107. Server 115 may provide MD public key 223 and MD private key 224 to merchant device 107. In some embodiments, merchant device 107 may generate MD public key 223 and MD private key 224 internally (cf. FIG. 2). Merchant device 107 then stores the above keys locally, in a memory.

At the beginning of each Epoch εₙ, customer 101 contacts server 115 with user credentials for a private account in service provider 110. Customer 101 may contact server 115 using customer device 103, and link 161 through network 150. Server 115 then provides customer device 103 with signed scrip 100 including public key 201. Public key 201 may be specifically created for the private account of customer 101, and have associated with it a radius around a center location and an expiration time, defined by Epoch εₙ.

At a time when customer 101 is ready to make a purchase with merchant 102, customer device 103 requests invoice 170 via NFC 105 from merchant device 107. Merchant device 107 presents invoice 170 to customer device 103 via NFC 109. Invoice 170 may be as described in detail above, in relation to FIG. 4. In some embodiments, MDS public key 221 in invoice 170 may be signed by private key 202. Invoice 170 is in turned signed by MDS private key 222.

Customer device 103 extracts MDS public key 221 from invoice 170 and verifies its authenticity with private key 202. Customer device 103 then verifies the entire invoice's signature with MDS public key 221. Once customer device 103 has verified the authenticity of merchant 102, customer device 103 checks if any signed scrip 100 contained in its memory matches the invoice. Checking for a signed scrip 100 that matches invoice 170 may include verifying that the signed scrip 100 has not expired. Also, checking for a signed scrip 100 that matches invoice 170 may include verifying that customer device 103 is within the correct geographic range, as determined by the location radius of signed scrip 100. If customer device 103 finds a signed scrip 100 that matches invoice 170, customer device 103 generates and includes key tmpk 251 in signed scrip 100, together with stamp 330 including current time and location of customer device 103. Customer device 103 encrypts signed scrip 100 with MD public key 223 and sends it to merchant device 107, for payment.

Merchant device 107 verifies the signature of signed scrip 100 with public key 201 and checks the details of signed scrip 100 against invoice 170. In some embodiments, merchant device 107 checks if GUID 320 in signed scrip 100 is within the proper radius of merchant device 107. Merchant device 107 also checks if GUID 320 in signed scrip 100 has expired. If GUID 320 in signed scrip 100 is valid, merchant device 107 creates reduced scrip 190 by amending signed scrip 100 with the details of the current transaction as listed in invoice 170. In some embodiments, merchant device 107 appends MDS public key 221 (signed by private key 202) and signs the entire reduced scrip 190 with MDS private key 222. Merchant device 107 may also encrypt a return message in reduced scrip 190 using tmpk 251 provided by customer device 103. Customer device 103 receives, decodes, and stores reduced scrip 190 locally.

Customer 101 may perform another purchase with reduced scrip 190 before contacting service provider 110 again. For example, before the expiration of GUID 520 in reduced scrip 190, customer 101 may contact a new merchant 102. A new merchant device 107 is able to authenticate reduced scrip 190 by verifying the MDS public key 221 in reduced scrip 190 using private key 202. In fact, a copy of private key 202 may be provided by server 115 to all merchant devices 107 participating of system 140. Then, new merchant device 107 validates the entirety of reduced scrip 190 with MDS public key 221. In fact, new merchant device 107 can review signed scrip 100, which is included in reduced scrip 190 with the appropriate signatures (cf. FIG. 5). Thus, new merchant 107 may verify the original value in reduced scrip 190. After processing a new transaction, new merchant device 107 may further reduce the credit value of reduced scrip 190, forming a new reduced scrip 190 having the appropriate MD and MDS public and private signatures from the new merchant device 107. Subsequent merchant devices can verify each link in the chain to check for the validity of the new reduced scrip passed along by customer device 103.

After a purchase transaction is successfully completed, merchant device 107 and customer device 103 both send a copy of reduced scrip 190 to server 115, through network 150. Thus, service provider 110 may validate the authenticity of the information received from customer device 103 and merchant device 107 using the signature chains form each copy of reduced scrip 190. Merchant device 107 and customer device 103 may also send server 115 a copy of invoice 170. Service provider 110 may compare reduced scrip 190 with invoice 170 using new GUID 520 generated by merchant device 107 (cf. FIG. 5). Once the authenticity of the transaction is condoned, service provider 110 may transfer to the account of merchant 102 an amount of money for the redemption of invoice 170. Likewise, service provider 110 may withdraw from the account of customer 101 an amount of money equivalent to the value of invoice 170. In some embodiments, server 110 immediately charges the account of customer 101. In some embodiments, server 110 may keep a data log of the transaction in memory circuit 112 for later charges. Furthermore, server 110 may provide customer 101 with a new signed scrip 100 using new encrypted keys, a new expiration date, and new, replenished credit amount.

Abuse of system 140 can be grouped into three broad classes: a malicious customer device 103, a malicious merchant device 107, or a compromise of service provider 110. Forgery of signed scrip 100 by either a malicious customer device 103 or a malicious merchant device 107 is prevented through the signature system using the encrypted keys (cf. FIG. 2). A malicious customer device 103 could attempt to re-use signed scrip 100 after a purchase, instead of using reduced scrip 190. A customer attempting to re-use signed scrip 100 multiple times would be able to succeed for as long as it takes to at least one merchant device 107 to communicate a reduced scrip 190 and invoice 170 to service provider 110, through link 162 and network 150. Once two merchant devices 107 provide two reduced scrips 190 and two invoices 170 having the same GUID 320, the fraud will be immediately detected by server 115. Then, server 115 may add fraudulent GUID 320 to a blacklist. Furthermore, server 115 may provide the blacklist of fraudulent GUIDs to all merchant devices 107 within the radius of compromised signed scrip 100. For example, server 115 may broadcast the blacklist through network 150 using link 163. In some embodiments, server 115 may provide merchant devices 107 with an updated blacklist as the devices make contact with server 115. A merchant device 107 that detects a signed scrip 100 including a blacklisted GUID 320 may reject the signed scrip 100 using local link 165. In embodiments including an expiration time on signed scrip 100, the blacklist may also be renewed by server 115 for each Epoch εₙ. Likewise, merchant device 107 may remove from memory a GUID 320 once signed scrip 100 expires at the end of the corresponding Epoch εₙ.

A malicious customer device 103 may also attempt to use signed scrip 100 obtained by customer 101 without permission (i.e., stolen). A stolen signed scrip 100 may occur when customer device 103 is compromised, lost, or stolen, and an illegitimate user spends stolen signed scrip 100 until credit runs out, or until signed scrip 100 expires. Once legitimate customer 101 contacts service provider 110 to renew signed scrip 100 or to report the loss, the fraud will be exposed. Even in cases where fraud is not detected until signed scrip 100 has been fully spent, the fraud is limited to the amount issued in signed scrip 100. In some embodiments, service provider 110 sends an e-mail to customer 101 with receipts including invoice 170. Customer 101 may access e-mail through a device other than customer device 103, and thus be alerted of a third party abuse of signed scrip 100. Accordingly, in some embodiments server 110 immediately blacklists the most recent signed scrip 100 if customer 101 disputes the charge.

A malicious merchant device 107 might attempt to steal signed scrip 100 from an uncompromised customer device 103, or to charge a different amount than was represented to customer 101 in invoice 170. A merchant device 107 without access to encrypted keys (cf. FIG. 2) would not be efficient in stealing signed scrip. Even if a malicious merchant device 107 replayed an invoice prompt from a non-compromised merchant device, malicious merchant device 107 would not be able to decrypt the resulting signed scrip message.

A compromised merchant device with access to private key 202 could steal signed scrip 100, but would quickly run into the same problems as a malicious customer device: stolen signed scrip 100 must be used before its Epoch expires, at which point the fraud is noticed by server 110.

In some embodiments malicious merchant device 107 might attempt to charge an amount different from what customer 101 expects. In such situations, the fraud is detected when server 115 compares copies of invoice 170 received from customer device 103 and from merchant device 107. In case of fraud, a receipt received by customer 101 using a different system will reveal any pricing changes. A malicious vendor doing this frequently would be discovered and merchant device 107 placed in a blacklist.

To avoid fraud and abuse of system 140, some embodiments include protection of MDS public key 221, MDS private key 222, MD public key 223, and MD private key in a tamper-resistant security module (TRSM). This allows service provider 110 to issue new keys to merchant devices 107 on a longer lease, e.g., for Epochs or lifetimes longer than customer device—related encrypted keys such as public key 201.

Malefactors may attempt to compromise server 115 directly. For example, attacks may be directed to access private key 202. To prevent this, the highest level of security may be used with private key 202. In addition, the Epoch system provides isolation and a failsafe to system 140. Merchant device 107 and customer device 103 may link to server 115 through network 150 on a regular basis. As such, server 115 is addressable over network 150, and is thus vulnerable. However, customer device 103 and merchant device 107 do not need access to private key 202. A rapidly changing public key 201 can be generated and signed by a firewalled server 115 including private key 202. Public key 201 is then pushed out to peripheral servers that provide public key 201 to customer device 103 and merchant device 107. A similar system can be set up for MDS public key 221, MDS private key 222, MD public key 223, and MD private key 224. These merchant device keys may be cycled at a different schedule compared to the customer keys. In general, merchant devices are assumed to be more secure, so merchant device keys may be cycled at a lower rate than customer device keys.

According to some embodiments, when private key 202 is compromised and counterfeit signed scrip created, service provider 110 will become aware of it as reduced scrip 190 or invoice 170, returned from merchant device 107 and customer device 103, will not match the private keys in memory circuit 112. Thus, service provider 110 may stop issuing new signed scrip 100, until system 140 shuts down as the current Epoch expires. When system 140 shuts down, even counterfeit signed scrip 100 is eliminated.

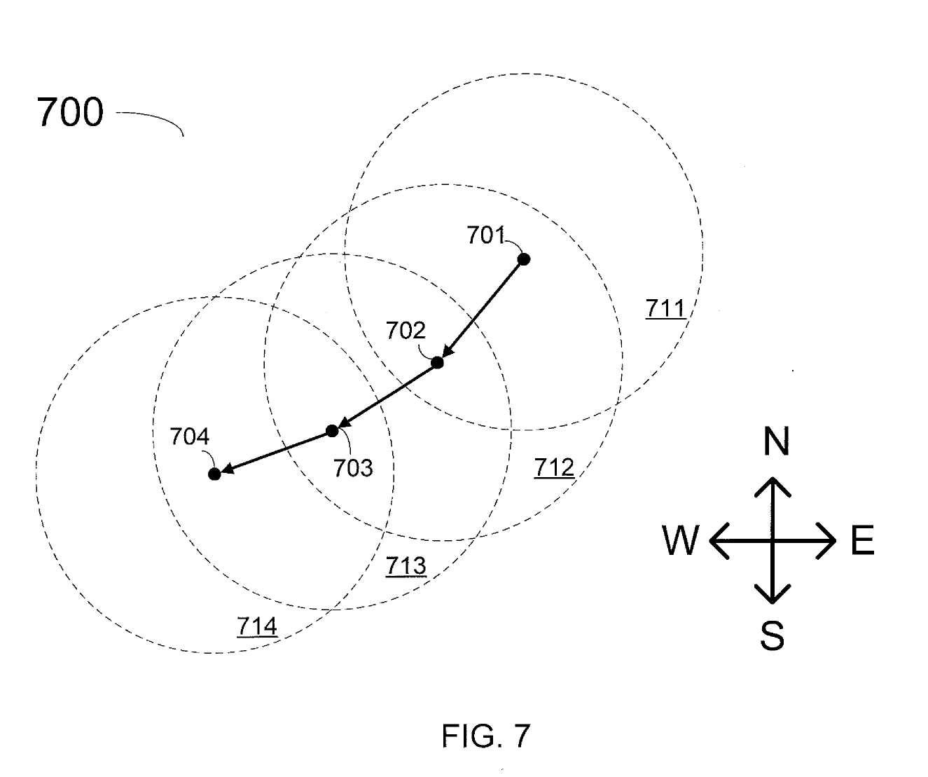

FIG. 7 illustrates a trajectory 700 in a system 140 for instantaneous retail payment, according to some embodiments. Customer 101 may follow trajectory 700 making purchases with different merchant devices centered on points 701, 702, 703 and 704. In some embodiments, the sequence of points 701, 702, 703 and 704 may extend beyond the geographic restriction 711 imposed by GUID 320 around first purchase location 701. In some embodiments, a second purchase at point 702 may be allowed by GUID 320 since point 702 is within geographic area 711. After the second purchase at point 702, the new GUID 520 in reduced scrip 190 may have a new location center at point 702. Thus, a new geographic restriction area 712 centered around point 702 may extend beyond geographic area 711. After a few iterations, a trajectory 700 may be formed, including extended restriction areas 711, 712, 713, and 714. In embodiments consistent with the present disclosure, customer 101 is allowed to wander around an extended area, still making purchases with the remaining balance in signed scrip 100.

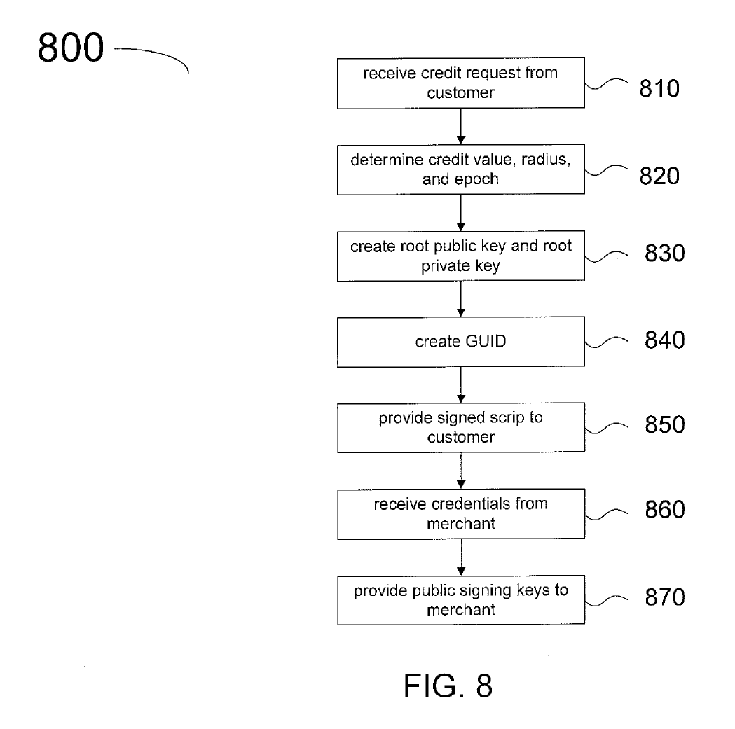

FIG. 8 illustrates a flow chart of a method 800 for instantaneous retail payment, according to some embodiments. According to some embodiments, method 800 may be performed by server 115 using processor circuit 111 and memory circuit 112. For example, method 800 may be performed by commands stored in memory circuit 112 which when executed by processor circuit 111 induce server 110 to perform at least all the steps in method 800. Steps in method 800 including receiving or providing information by server 115 to and from customer 101 and merchant 102 may include using processor circuit 111 to link with network 150 using data link 163.

In step 810, server 115 receives a credit request from customer 101. Customer 101 may be a registered user having a private account with service provider 110. In some embodiments, step 810 may be skipped and service provider 110 may start method 800 from step 820 without a request from customer 101. In step 820, server 115 determines a credit value, a geographic limit, and an Epoch to provide the requested credit to customer 101. The geographic limit may be a circle having a radius, the circle centered at the current location of customer 101. In step 820, server 115 may use processor circuit 111 to perform a risk assessment of customer 101 according to a transaction history for customer 101. The transaction history for customer 101 may be stored in memory circuit 112. The geographic limit and Epoch may be determined based on user purchase and/or rating information, user location (e.g., whether the user is near a home/office or vacation/business trip), whether the current user location is densely populated with shopping or in a more rural area, user spending habits in the area, during the time period, or in general, and/or other factors as applicable. The user and/or the service provider may determine the geographic limit and Epoch. In step 830, server 115 creates root public key 201 and root private key 202. Server 115 may use processor circuit 111 running an asymmetric encryption algorithm stored in memory circuit 112, in step 830. In some embodiments, public key 201 and private key 202 may be associated to an Epoch, or a restricted time having a start time and a deadline.

In step 840, server 115 creates GUID 320. GUID 320 may include an expiration time according to the Epoch associated to private key 201 and public key 202. The expiration time may be based on the same or similar information above for determining the geographic limit and Epoch. For example, the user may specify a larger geographic area (but not centered around the user's current location) and a longer expiration time because the user is planning to travel in a general direction through a large rural area with “spotty” communication coverage. GUID 320 may also include a geographic limit of validity for a transaction carried out using public key 201. In step 840 server 115 may package together signed scrip 100 including all elements described in detail in relation to FIG. 3. In step 850 server 115 provides signed scrip 100 to customer 101.

In step 860 server 115 receives credentials from merchant 102. Merchant 102 may desire to register for instantaneous payment system 140 using an already existing account with service provider 110. Merchant 102 may also provide specifications and details of merchant device 107 which merchant 102 may use for accessing server 115. Merchant 102 may use merchant device 107 to communicate with customer device 103 from customer 101. In some embodiments, step 860 may include verification by server 115 that merchant machine 107 is capable of establishing local link 165 with potential users, for example using NFC device 109. Furthermore, server 115 may ensure in step 860 that merchant device 107 is capable of performing asymmetric encryption algorithms to generate MD public key 223, and MD private key 224.

In step 870, server 115 provides public key 201 to merchant 102. Public key 201 and private key 202 may be associated with signed scrip 100 provided to customer 101 in step 850. Furthermore, public key 201 and private key 202 may be associated with an Epoch having a start time and a deadline. In some embodiments, merchant 102 having a public key 201 and a private key 202 may request a new public key 201 and a new private key 202 from server 115 at a deadline time for the current keys. Thus, server 115 may repeat steps 860 and 870 at each Epoch deadline.

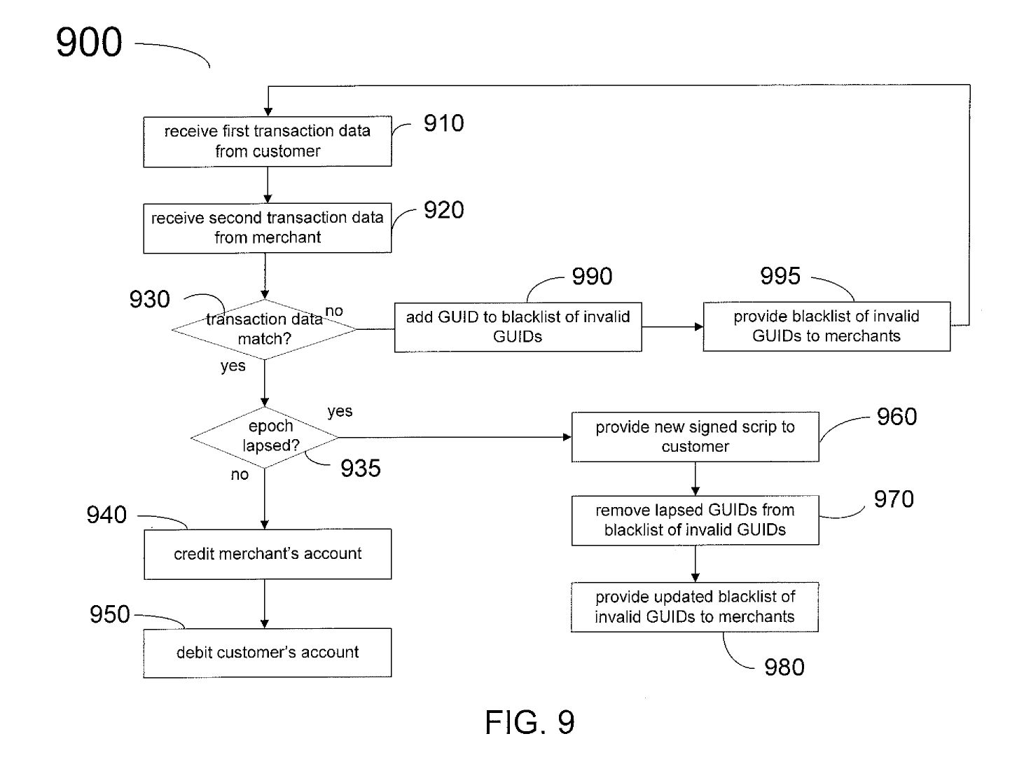

FIG. 9 illustrates a flow chart of a method 900 for instantaneous retail payment, according to some embodiments. According to some embodiments, method 900 may be performed by server 115 using processor circuit 111 and memory circuit 112. For example, method 900 may be performed by commands stored in memory circuit 112 which when executed by processor circuit 111 induce server 110 to perform at least all the steps in method 900.

In step 910, server 115 receives a first transaction data from customer 101. The first transaction data may include a customer copy of invoice 170, signed scrip 100, and a customer copy of reduced scrip 190. In step 920, server 115 receives a second transaction data from merchant 102. The second transaction data may include a merchant copy of invoice 170, and a merchant copy of reduced scrip 190.

In step 930, server 115 checks whether the first transaction data matches the second transaction data. Step 930 may also include authentication by server 115 of the signature keys in signed scrip 100, invoice 170, and reduced scrip 190. In step 935 a check is performed as to whether the Epoch for signed scrip 100 has lapsed, and if the time stamp in stamp 430 on invoice 170 and the time stamp in stamp 530 in reduced scrip 190 is prior to the Epoch deadline. Also, step 935 may include checking that the location of the transaction according to stamps 430 and 530 is within the restricted geographic region. Thus, after steps 930 and 935 are completed satisfactorily, server 115 is able to determine the authenticity of the purchase transaction between customer 101 and merchant 102.

In step 940, server 115 credits the private account of merchant 102 when the purchase transaction is authentic. Thus, in step 940 server 115 may transfer the transaction amount listed on invoice 170 into the private account of merchant 102. In step 950 server 115 debits the private account of customer 101 when the purchase transaction is authentic.

In some situations, the amount in invoice 170 may be higher than value 310 in signed scrip 100 (cf. FIG. 3). In such situations, some embodiments include server 115 performing the purchase transaction between customer 101 and merchant 102 through network 150, using links 161, 162, and 163. Accordingly, this type of transaction may take more time since a network link between remote parties is used. Other than the time delay, customer 101 may not even notice that the transaction went through via direct online communication, or instantaneously through local link 165 with merchant device 107.

In step 960, server 115 provides a new signed scrip 100 to customer 101 when the Epoch has lapsed. The fact that customer 101 attempts to make a transaction after the Epoch has lapsed may not necessarily imply an abuse of system 140 from the part of customer 101 or of merchant 102. In step 970 server 115 removes lapsed GUIDs from the blacklist of invalid GUIDs when an Epoch has lapsed according to step 935. In step 980, server 115 provides an updated blacklist of invalid GUIDs to vendors, including merchant 102. In some embodiments, server 115 may perform steps 960, 970, and 980 routinely for every Epoch deadline, for every customer 101 and merchant 102 registered for retail payment system 140, and for every pair of public key 201 and private key 202 issued. Thus, server 115 may enhance the security of retail payment system 140 against fraud and malicious attacks.

In step 990, server 115 adds GUID 320 to blacklist of invalid GUIDs when the first transaction data provided by customer 101 does not match the second transaction data from merchant 102 in step 930. In step 995, server 115 provides the updated blacklist of invalid GUIDs to merchants. At this point, server 115 may be ready to receive new transaction data from a customer and a merchant.

Embodiments described above are exemplary only. One skilled in the art may recognize various alternative embodiments from those specifically disclosed. For example, the above designed description focused on a service provider handling an authentication for a user involved in a payment transaction with a merchant. However, the authentication, signing and encrypting schemes discussed herein can be implemented by retailers, government agencies, universities, schools, and any entity that may require a user to be authenticated before accessing certain information or taking an action. Those alternative embodiments are also intended to be within the scope of this disclosure. As such, the invention is limited only by the following claims.

1. A system for performing a retail payment between a customer and a merchant, the system comprising:
a signed scrip, the signed scrip comprising: a public key, a credit value, a signed scrip validation stamp, a credit value, and a validation stamp;
a signed invoice comprising a transaction list and an invoice validation stamp; and
a private key complementary to the public key, wherein
the public key is used to decode the signed scrip;
the private key is stored in a server coupled to a network; and the private key is used by the server to validate the authenticity of the signed invoice.

2. The system of claim 1 further comprising:
a memory circuit storing commands for an asymmetric encryption algorithm; and
a processor circuit configured to provide the public key and the private key executing commands in the asymmetric encryption algorithm.

3. The system of claim 1 wherein the signed scrip further comprises an epoch to synchronize use of the signed scrip between the customer and the merchant.

4. The system of claim 1 wherein the signed invoice comprises a second public key and a second private key complementary to each other.

5. The system of claim 4 wherein the signed invoice comprises a signature encoded by a merchant device.

6. The system of claim 5 further comprising a reduced scrip having a reduced value, the reduced scrip comprising the second public key, the second private key, and the signature encoded by the merchant device.

7. The system of claim 6 wherein the reduced value is the subtraction of an invoice total in the transaction list to the credit value of the signed scrip.

8. The system of claim 1 wherein the signed scrip validation stamp includes a geographic validation stamp and a time limit stamp.

9. The system of claim 1 wherein the invoice validation stamp include a time stamp and a location stamp.

10. The system of claim 8 wherein the time stamp is within a time restriction limit and the location stamp lies within a geographic restriction.

11. The system of claim 1 further comprising a blacklist of potentially fraudulent signed scrips.

12. A method for performing a financial transaction, comprising:
receiving a request, by a service provider from a customer through a customer device, to generate a signed scrip;
transmitting, by the service provider, the signed scrip to the customer device, wherein the signed scrip is stored on the customer device and comprises an amount, a geographic restriction, and a time restriction; and
receiving, by the service provider, a reduced scrip from the customer and from a merchant, wherein the signed scrip was used to make a payment to the merchant using a link between the customer and the merchant, and wherein the reduced scrip is generated by the merchant; and wherein a time stamp in the reduced scrip received from the customer and a time stamp in the reduced scrip received from the merchant occur within an epoch in the signed scrip.

13. The method of claim 12 further comprising:
generating a signature for the signed scrip;
generating a public key; and
generating a private key; wherein
the public key and the private key are complementary; and
the signature is encrypted using one of the public key and the private key.

14. The method of claim 13 further comprising:
transmitting the public key to the customer and to the merchant.

15. The method of claim 12 further comprising:
generating a merchant signature for the reduced scrip; and
generating a merchant public key and a complementary merchant private key; wherein
the merchant signature is encrypted using one of the merchant public key and the merchant private key.

16. The method of claim 12, further comprising generating a blacklist of potentially fraudulent signed scrips.

17. A non-transitory machine-readable medium comprising a plurality of machine-readable instructions which when executed by one or more processors of a server controlled by a service provider are adapted to cause the server to perform a method comprising:
receiving a credit request from a customer;
determining credit parameters;
creating a public key;
providing a signed scrip to a customer;
receiving credentials from a merchant;
determining an epoch for the signed scrip for synchronizing the customer with the merchant; and
providing the public key to the merchant.

18. The non-transitory machine-readable medium of claim 17 wherein the method performed by the server comprises:
creating a private key complementary to the public key; and
creating a global unique identifier (GUID) for the signed scrip, the GUID comprising: a time restriction and a geographic restriction.

19. The non-transitory machine-readable medium of claim 17 wherein the determining the credit parameters comprises:
determining a credit value;
determining the geographic restriction; and
determining the time restriction based on a purchase history of a private account of the customer with the service provider.

20. The non-transitory machine-readable medium of claim 19, wherein the method performed by the server comprises:
generating a blacklist of potentially fraudulent signed scrips; and
cancelling the transaction when the signed scrip is in the blacklist.
